(19) United States
(12) Patent Application Publication
(10) Pub. No.: US 2009/0041916 A1
(43) Pub. Date: Feb. 12, 2009

(54) Method and device for cold-embossing a fatty food mass

(76) Inventors: Achim Krischer, Wipperfurth (DE); David Marcinokowski, Waldbrol (DE)

Correspondence Address: WOLFF & SAMSON, P.C., ONE BOLAND DRIVE, WEST ORANGE, NJ, 07052, US

(21) Appl. No.: 11/918,638

(22) PCT Filed: Feb. 6, 2006
(86) PCT No.: PCT/CH2006/000073

§ 371 Date: Oct. 15, 2007

(30) Foreign Application Priority Data
Apr. 13, 2005 (DE) 10 2005 017 176.1

(51) Int. Cl. A23G 1/50; A23G 3/02

(52) U.S. Cl. 426/512; 425/385

(57) ABSTRACT

The invention relates to a device and to a method for producing a consumable product, which is made of, at least partially, a fatty mass (M), in particular, containing cocoa and/or chocolate. Said device comprises a bearing surface (3; 4; 5) and a concave cooling stamp (1) which can be lowered onto the bearing surface (3; 4; 5), said cooling stamp comprising a concave stamp area (2) on the under side thereof, whereby the inner surface thereof is complementary to a first surface of a consumable product which is to be produced. A warm, soft lump of fatty mass (M) is applied to the bearing surface (3, 4) or to the surface of a undecorated consumable product (7) in order to carry out said method and is hardened by cold pressing by means of the concave cooling stamp (1). As a result, specifically formed and decorated consumable products which are made from chocolate are produced and/or undecorated consumable products are specifically decorated with chocolate.

The invention relates to a method and a device for manufacturing a consumable, at least parts of which consist of a fatty substance, in particular a cocoa-containing or chocolate-like fatty substance.

Consumables that at least partially consist of a fatty substance include cookies or similar baked goods, on which a “bonnet” or a “blob” or “clump” of chocolate is applied, or a white chocolate bar, for example, embossed with a dark chocolate pattern, e.g., so-called “chocolate thalers” or “chocolate pictures”, or vice versa.

In conventional methods, the bonnets or blobs are applied or embossed on the generally solid substrate (e.g., cookie or chocolate bar) in a flowing to pasty form, and then cooled until the applied or embossed substance has cooled.

This cooling process requires a relatively long time, so that it slows the overall production rate for the consumables mentioned at the outset, or necessitates a very large refrigerated storage unit.

GB-A-2 070 501 describes a device for manufacturing chocolate articles. In this case, a mold cavity was defined by a substrate, an annular structure on the substrate and a stamp, which can be moved from top to bottom into the space enveloped by the ring. The annular structure laterally bordering the mold cavity is provided with cooling channels. However, the lowerable stamp does not exhibit any cooling channels.

EP-A-1 356 738 and WO-98/3011 also describe devices for manufacturing chocolate articles via molding or embossing. The embossing stamps contain no cooling channels here either.

The object of the invention is to provide a method and device suitable for quickly manufacturing a consumable, at least parts of which consist of a fatty substance, in particular a cocoa-containing or chocolate-like fatty substance.

This object is achieved by the method according to claim 1 and the device according to claim 9.

In order to manufacture a consumable, at least parts of which consist of a fatty substance, in particular a cocoa-containing or chocolate-like fatty substance, the method according to the invention involves the following steps:
Applying a metered quantity of fatty substance in a soft, yet dimensionally stable state onto a solid bearing surface, so that a blob of fatty substance with a defined volume is formed on the solid bearing surface;
Lowering a concave cooling stamp, the lower end of which has a concave stamping area with an interior surface that complements the upwardly facing surface of the consumable to be manufactured, onto the blob of fatty substance, so that the fatty substance is distributed in the gap between the bearing surface and the interior of the concave stamp area; and
Holding the cooling stamp in its position lowered onto the blob of fatty substance for a specific period of time, until the fatty substance in the gap has hardened or solidified.

According to the invention, the concave cooling stamp is traversed by coolant channels. A coolant that dissipates heat coming from the fatty substance blob here circulates through the mounting device in the concave cooling stamp.

Since the fatty substance is present in a soft, yet dimensionally stable or at least highly viscous state, the blob of fatty substance applied to the bearing surface flows very slowly if at all, so that it does not need to be limited by a lateral demarcation on the bearing surface. As a result, the concave stamp area of the concave cooling stamp that was lowered onto the blob shortly after the blob of fatty substance was applied envelops virtually the entire blob, so that the blob of fatty substance is embossed with a complementary image of the concave stamp area. The cooling stamp best has a temperature of below 10° C., but preferably under 0° C., so that the embossed blob of fatty substance is cooled and hardened or solidified very quickly if the cooling stamp is held in its position lowered onto the blob of fatty substance. The cooling stamp is held in this lowered position until the blob of fatty substance has sufficiently solidified, and the stamp can be detached from the solidified blob of fatty substance without damaging the end product. Therefore, one usually does not wait until the blob of fatty substance has completely hardened.

It is here especially advantageous to execute the described embossing process in an atmosphere having an air-conditioned dew point lying below the surface temperature of the concave cooling stamp. This ensures that neither dew nor frost will be deposited on the surface of the cooling stamp, which as a rule would lead to spots forming on the surface of the embossed blob of fatty substance. This yields perfect, especially lustrously embossed fatty substances on the solid substrates.

The solid bearing surface can be a flat surface, or exhibit a concave bearing area, the inner surface of which is complementary to the downwardly facing surface of the consumable to be manufactured, wherein the blob of fatty substance is applied to this concave bearing area. Depending on the shape of the concave cooling stamp and the shape of the bearing surface, this makes it possible to form chocolate thalers or biconvex and plano-convex chocolate lenses.

It is especially advantageous for the bearing surface to be comprised of the surface area of an existing consumable. As a result, cookies or other baked goods along with chocolate bars can be decorated with embossed chocolate structures and aesthetically enhanced.

After lowering the cooling stamp, the edge area of the concave cooling stamp encompassing its concave stamping area is best pressed against the bearing surface, in order to seal off the gap filled with fatty substance. This prevents a portion of the fatty substance from leaking out in the embossing process. As a result, the edge area of the concave cooling stamp yields embossed fatty substance with borders.

As an alternative, the selected defined volume of the fatty mass blob can exceed the volume of the gap between the bearing surface and the concave stamping area. This causes a portion of the fatty substance to swell beyond the stamping area during the embossing process, yielding embossed structures resembling a seal.

The embossing process can also take place in such a way as to press the edge area of the concave cooling stamp, which encompasses its concave stamping area and exhibits notches or indentations, against the bearing surface after lowering the cooling stamp. This again forces a portion of the fatty substance out of the filled gap. Specially arranging the notches or indentations along the circumferential direction of the stamp edge area makes it possible to fabricate embossed fatty substance structures enveloped by specially distributed surge areas or leak areas comprised of fatty substance.

To manufacture the consumable, at least portions of which consist of a fatty substance, in particular a cocoa-containing or chocolate-like fatty substance, use is made of a device according to the invention, which has a solid bearing surface and a concave cooling stamp that can be lowered onto the bearing surface, the lower end of which has a concave stamping area, with an interior surface that complements first surface area of the consumable to be manufactured.

According to the invention, the concave cooling stamp with is traversed by coolant channels, wherein a coolant can be circulated through the mounting device in the concave cooling stamp.

The solid bearing surface can also be a flat surface, or exhibit a concave bearing area with an interior surface complementary to a second surface area of a consumable to be manufactured, or it can exhibit a cavity under the cooling stamp for accommodating a present consumable.

The concave cooling stamp preferably exhibits an edge area that encompasses its concave stamping area, with which the cooling stamp can be pressed against the bearing surface, wherein the concave cooling stamp in particular exhibits an edge area that envelops its concave stamping area and is provided with notches or indentations, and can be used to press the cooling stamp against the bearing surface.

The method according to the invention can also be used to “weld” or “solder” several, if necessary different, consumables together. To this end, the various consumables are placed one next to another on a solid support, and a blob of fatty substance is applied to the solid support in such a way that the blob of fatty substance encompasses the two adjacent areas. The concave stamping area is here preferably provided with indentations in the edge area that are approximately complementary to the adjacent consumable areas, so that a portion of the fatty substance swells out of the stamping area and wets the adjacent consumable areas prior to hardening. This makes it possible to realize relatively stable consumable structures with “chocolate weld points” or “chocolate solder points”, for example.

Additional advantages, features and possible applications of the invention can be gleaned from the description of various embodiments of the invention based on the drawing, which are not to be construed as limiting. Shown on:

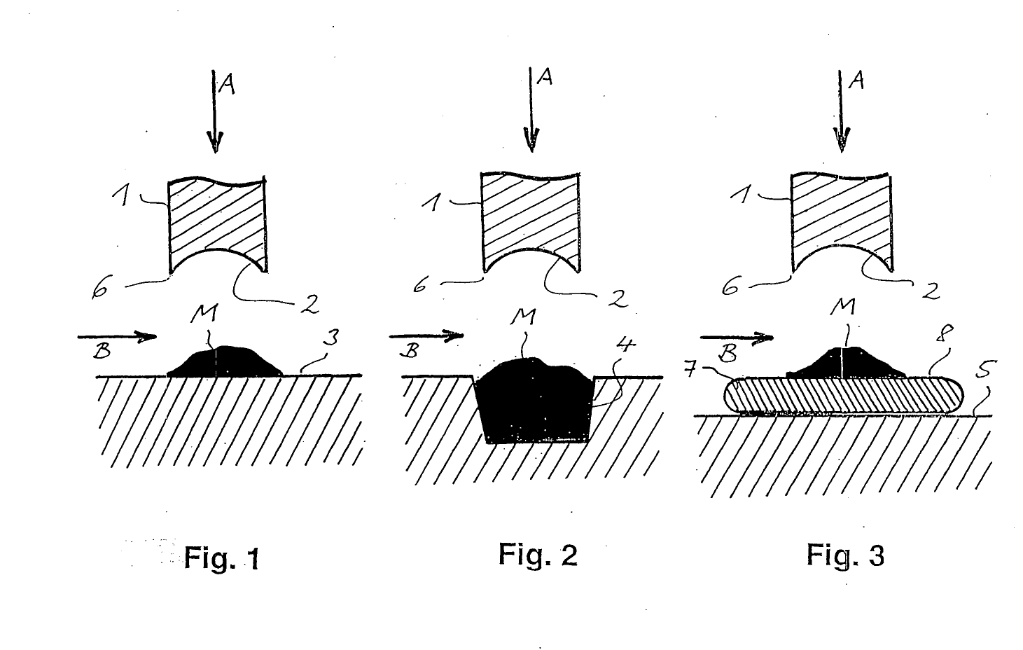

FIG. 1 is a sectional, diagrammatic view of a first embodiment of the device according to the invention during the cooling stamp lowering phase of the method according to the invention;

FIG. 2 is a sectional, diagrammatic view of a second embodiment of the device according to the invention during the cooling stamp lowering phase of the method according to the invention; and

FIG. 2 is a sectional, diagrammatic view of a third embodiment of the device according to the invention during the cooling stamp lowering phase of the method according to the invention.

FIG. 1 shows a diagrammatic view of a first embodiment of the device according to the invention. It contains a concave cooling stamp or hollow stamp 1 with a concave stamping area 2 along with a solid bearing surface 3, which is a flat surface 3.

FIG. 1 shows the phase in which the concave cooling stamp or hollow stamps 1 moves down (arrow A) toward a blob M or clump of still warm and soft fatty substance that had previously been applied to the solid bearing surface 3. The bearing surface 3 can consist of a band, for example, which intermittently moves by and underneath the concave cooling stamp 1 (arrow B), while it is stopped during the downward movement of the concave cooling stamp 1. The concave cooling stamp 1 is then lowered down to the blob M, and pressed into the substance M. As a result, the fatty substance blob M is embossed with a pattern complementary to the surface of the concave stamping area 2. The concave cooling stamp 1 then remains on or in the fatty substance M until the latter has been sufficiently cooled and hardened by the cooling stamp 1.

An edge area 6 that envelops the concave stamping area 2 of the concave cooling stamp 1 can be pressed against the bearing surface 3, thereby generating a cavity volume defined between the concave stamping area 2 and the bearing surface 3, in which the fatty substance M becomes partially or completely distributed while being embossed prior to hardening. In this case, the fatty substance forming the blob M is incrementally applied to the bearing surface 3 in such a way that the fatty substance metering volume approximates the cavity volume between the concave stamping area 2 and the bearing surface 3.

As a rule, the quantity metered is to some extent a bit too low, so as to prevent excess fatty substance M from swelling out of the cavity volume. This makes it possible to very quickly manufacture plano-convex chocolate lenses or, given appropriately shaped hollow stamps 1, chocolate thaler and the like, since the cooling time for the fatty substance M is exceedingly short owing to the low temperature (under 10° C., preferably under 0° C.) of the cooling stamp 1.

A slightly excessive quantity can be metered, accepting the fact that a portion of the fatty substance will swell out between the edge area 6 of the cooling stamp 1 and the bearing surface 3 in the embossing process at the end of the cooling stamp lowering phase. The edge area 6 can also be very specifically provided with notches or indentations (not shown) along the periphery, so that the arising cavity is open to the outside via one or more holes when the cooling stamp 1 is completely lowered against the bearing surface 3. When embossing with an excessive metered quantity, the excess fatty substance M then swells outward through these holes. As a result, not just an embossing pattern can be fabricated on the concave stamping area 2 during the embossing process, but also numerous molded structures can be obtained from the fatty substance owing to the fatty substance M swelling out through the holes.

The concave cooling stamp 1 preferably consists of a readily thermally conductive metal, such as copper or aluminum, and the concave stamping area 2 that comes into contact with the fatty substance M in the embossing process is preferably coated with silver, which other than exhibiting excellent thermal conductivity, is also antiseptic. The bearing surface 3 can be made out of a plastic.

The device according to the invention preferably has numerous adjacent concave cooling stamps 1 arranged on a shared mounting device (not shown). A coolant that dissipates the heat coming from the fatty substance blob M circulates through the mounting device in the individual concave cooling stamps 1, which are traversed by corresponding coolant channels (not shown) for this purpose.

The concave cooling stamps 1 and the bearing surface 3 of the system according to the invention can be accommodated in a climate chamber, the dew point of which is held below the surface temperature of the concave stamping area 2 to prevent dew or frost formation on the latter.

FIG. 2 provides a diagrammatic view of a second embodiment of the device according to the invention. It also contains a concave cooling stamp 1 with a concave stamping area 2 along with a fixed bearing surface 4, which is a mold or alveolus 4.

FIG. 2 again depicts the phase in which the concave cooling stamp 1 moves downward (arrow A) toward a still warm and moist fatty substance M, which had previously been metered into the mold 4. The bearing surface with the molds can intermittently move by and underneath the concave cooling stamp 1 (arrow B), wherein it is stopped during the downward movement of the concave cooling stamp 1. The concave cooling stamp 1 is then lowered into the substance M in the mold 4, and pressed into the substance M. As a result, the fatty substance M is embossed with a pattern complementary to the surface of the concave stamping area 2. The concave cooling stamp 1 then remains on or in the fatty substance M until the latter has been sufficiently cooled and hardened by the cooling stamp 1.

In this way, massive or filled chocolate pieces can be decorated on top via embossing. In addition to enabling decoration, this accelerates the cooling and solidification of the fatty substance M in the mold 4. The alveolus can also incorporate a prefabricated product, which subsequently only receives one clump, which is then stamped according to FIG. 1, except that the substrate is not a band, but rather a praline in a mold.

FIG. 3 presents a diagrammatic view of a third embodiment of the device according to the invention. It also contains a concave cooling stamp 1 with a concave stamping area 2 and a fixed bearing surface 5, which is a substrate 5 that holds an undecorated consumable 7. The latter is here a baked item, a cookie or a piece of (hardened) chocolate fabricated beforehand in some other way.

FIG. 3 depicts the phase in which the concave cooling stamp or hollow stamp 1 moves downward (arrow A) toward a blob M or clump of still warm and soft fatty substance, which had previously been applied to the upper surface 8 of the undecorated consumable 7. The substrate 5 can intermittently move by and underneath the concave cooling stamp 1 (arrow B), wherein it is stopped during the downward movement of the concave cooling stamp 1. The concave cooling stamp 1 is then lowered up to the blob M, and pressed into the substance M. As a result, the fatty substance blob M is embossed with a pattern complementary to the surface of the concave stamping area 2. The concave cooling stamp 1 then remains on or in the fatty substance M until the latter has been sufficiently cooled and hardened by the cooling stamp 1.

If the undecorated consumable 7 is a baked good or cookie, the interior bond between the applied fatty substance M and the surface 8 of the consumable is intensified even further by the rapid embossing process.

If the undecorated consumable 7 is a piece of solidified chocolate (e.g., room temperature, approx. 20° C.), an interior bond between the applied warm fatty substance M (e.g., 30-36° C.) and the surface 8 of the consumable comes about, since the solidified chocolate partially softens and melts the surface 8. The subsequent embossing process intensifies this intimate bond even further. The undecorated consumable 7 can be white chocolate, while the applied fatty substance M is brown or dark chocolate, or vice versa.

Special configurations of the edge area 6 of the concave cooling stamp 1 make it possible to decorate the undecorated consumable 7 in a wide variety of ways, even in this third embodiment. The corresponding device and method-related methods correspond to those in the first embodiment, and were described on FIG. 1 relative to the edge areas 6.

While the invention was described above in such a way as to imply that the bearing surface 3 is intermittently passed by and below the concave cooling stamp 1, the structural design can also be modified in such a way that the concave cooling stamp 1 moves along with the bearing surface 3. As an advantageous consequence, the bearing surface 3 or the flat band, the mold 4 or the substrate 5 do not have to be stopped during cold embossing.

### REFERENCE LIST

1 Concave cooling stamp/hollow stamp
2 Concave stamping area
3 Bearing surface/flat surface
4 Bearing surface/mold
5 Bearing surface/substrate
6 Edge area of concave cooling stamp
7 Undecorated consumable
8 Surface of undecorated consumable
M Fatty substance

1-14. (canceled)

15. A method for manufacturing a consumable, at least parts of which consist of a fatty substance, wherein the method comprises the steps of:
applying a metered quantity of fatty substance in a soft, yet dimensionally stable state onto a fixed bearing surface, so that a blob of fatty substance with a defined volume is formed on the solid bearing surface;
lowering a concave cooling stamp arranged on a mounting device, a lower end of which has a concave stamping area with an interior surface that complements an upwardly facing surface of the consumable to be manufactured, onto the blob of fatty substance, so that the fatty substance is distributed in a gap between the bearing surface and the interior surface of the concave stamp area; and
holding the cooling stamp in its position lowered onto the blob of fatty substance for a specific period of time, until the fatty substance in the gap has hardened wherein the concave cooling stamp is traversed by coolant channels, wherein a coolant that dissipates heat coming from the fatty substance blob circulates through the mounting device in the concave cooling stamp.

16. The method according to claim 15, wherein the fixed bearing surface is a flat surface.

17. The method according to claim 1, wherein the fixed bearing surface exhibits a concave bearing area, having an interior that is complementary to a downwardly facing surface of the consumable to be manufactured, the fatty substance blob being applied to this concave bearing area.

18. The method according claim 15, wherein the bearing surface is formed by a surface area of an existing consumable.

19. The method according to claim 18, wherein the existing consumable consists of a solid fatty substance.

20. The method according to claim 19, wherein the existing consumable is a cocoa-containing or chocolate-like fatty substance.

21. The method according to claim 15, including, after the cooling stamp has been lowered, pressing an edge area of the concave cooling stamp encompassing the concave stamping area against the bearing surface, in order to seal off the gap filled with fatty substance.

22. The method according to claim 21, wherein the defined volume of the fatty substance blob exceeds a volume of the gap between the bearing surface and the concave stamping area.

23. The method according to claim 15, including, after the cooling stamp has been lowered, pressing an edge area of the concave cooling stamp, which encompasses its concave stamping area and exhibits notches or indentations, against the bearing surface, in order to force a portion of the fatty substance out of the filled gap.

24. A device for manufacturing a consumable, at least parts of which consist of a fatty substance, the device comprising a fixed bearing surface and a concave cooling stamp that is arranged on a mounting device and is lowerable onto the bearing surface, a lower end of the cooling stamp has a concave stamping area with an interior surface complementary to a first surface area of a consumable to be manufactured, the concave cooling stamp being traversed by coolant channels, wherein a coolant can be circulated through the mounting device in the concave cooling stamp.

25. The device according to claim 24, wherein the fixed bearing surface is a flat surface.

26. The device according to claim 25, wherein the fixed bearing surface exhibits a concave bearing area under the cooling stamp, an interior surface of which is complementary to a second surface area of a consumable to be manufactured.

27. The device according to claim 25, and further comprising a mold underneath the cooling stamp for accommodating a present or undecorated consumable.

28. The device according to claim 25, wherein the concave cooling stamp has an edge area that encompasses the concave stamping area, with which the cooling stamp can be pressed against the bearing surface.

29. The device according to claim 24, wherein the concave cooling stamp has an edge area that envelops the concave stamping area and is provided with notches or indentations, and is useable to press the cooling stamp against the bearing surface.
